(19) United States
(12) Patent Application Publication
(10) Pub. No.: US 2020/0185761 A1
(43) Pub. Date: Jun. 11, 2020

(54) LITHIUM-ION RECHARGEABLE BATTERY AND POSITIVE ELECTRODE OF LITHIUM-ION RECHARGEABLE BATTERY

(71) Applicant: SHOWA DENKO K.K., TOKYO (JP)

(72) Inventors: Akira SAKAWAKI, Ichihara-shi, Chiba (JP); Tatsunori SHINO, Ichihara-shi, Chiba (JP); Takaki YASUDA, Ichihara-shi, Chiba (JP)

(73) Assignee: SHOWA DENKO K.K., TOKYO (JP)

(21) Appl. No.: 16/638,952

(22) PCT Filed: Jul. 4, 2018
(86) PCT No.: PCT/JP2018/025352

§ 371 Date: Feb. 13, 2020

(30) Foreign Application Priority Data
Aug. 22, 2017 (JP) 2017-159622

(51) Int. Cl. H01M 10/0525; H01M 10/0562; H01M 4/131

(52) U.S. Cl. CPC H01M 10/0525; H01M 2004/028; H01M 4/131; H01M 10/0562

(57) ABSTRACT

A lithium-ion rechargeable battery (1) includes: a substrate (10); a positive electrode collector layer (20) stacked on the substrate (10); a positive electrode layer (30) stacked on the positive electrode collector layer (20); an inorganic solid electrolyte layer (40) stacked on the positive electrode layer (30); a negative electrode layer (50) stacked on the inorganic solid electrolyte layer (40); and a negative electrode collector layer (60) stacked on the negative electrode layer (50). The positive electrode layer (30) contains a mixture of an amorphized, solid electrolyte region (31) containing an inorganic solid electrolyte and a crystallized, positive electrode region (32) containing a positive electrode active material.

### TECHNICAL FIELD

The present invention relates to a lithium-ion rechargeable battery and a positive electrode of a lithium ion-rechargeable battery.

### BACKGROUND ART

With widespread use of portable electronics, such as mobile phones and laptop computers, a strong need exists for small and lightweight rechargeable batteries with a high energy density. Known examples of the rechargeable batteries meeting such a need include lithium-ion rechargeable batteries. The lithium-ion rechargeable battery includes a positive electrode containing a positive electrode active material, a negative electrode containing a negative electrode active material, and an electrolyte exhibiting lithium ionic conductivity and disposed between the positive electrode and the negative electrode.

Conventional lithium-ion rechargeable batteries have used an organic electrolyte solution and the like as an electrolyte. Meanwhile, use has been proposed of a solid electrolyte made of an inorganic material (inorganic solid electrolyte) as an electrolyte, and use has also been proposed of lithium phosphate compound with a composition ratio of LiₓNi_{y}PO_{z} (0<x<8.0; 2.0≤y≤10; z is a ratio where oxygen is stably contained depending on ratios of Ni and P) as a positive electrode (see Patent Document 1).

### CITATION LIST

### Patent Literature

Patent Document 1: Japanese Patent Application Laid-Open Publication No. 2013-164971

### SUMMARY OF INVENTION

### Technical Problem

Lithium-ion rechargeable batteries have been required to provide a larger capacity with a smaller volume. In particular, a need exits for making a positive electrode, which occludes lithium ions during a discharge, occlude more lithium ions.

An object of the present invention is to increase a specific capacity of a positive electrode in lithium-ion rechargeable batteries.

### Solution to Problem

According to a first aspect of the present invention, there is provided a lithium-ion rechargeable battery including: a solid electrolyte layer containing a solid electrolyte having lithium ionic conductivity; and a positive electrode layer facing the solid electrolyte layer, the positive electrode layer including a mixture of a positive electrode active material containing LiₐM_{b}O_{c} (where M is transition metal; a≠0, b≠0, c≠0) and an inorganic solid electrolyte containing LiₓP_{y}O_{z} (x≠0, y≠0, z≠0).

In the positive electrode layer of the above lithium-ion rechargeable battery, the positive electrode active material may be crystallized and the inorganic solid electrolyte may be amorphized.

In the positive electrode layer, the inorganic solid electrolyte may serve as a base material and particles of the positive electrode active material may be dispersed in the base material.

The positive electrode layer may contain more LiₐM_{b}O_{c} than LiₓP_{y}O_{z} in terms of molar ratio.

The solid electrolyte constituting the solid electrolyte layer may contain the same element as the inorganic solid electrolyte constituting the positive electrode layer.

According to a second aspect of the present invention, there is provided a positive electrode of a lithium-ion rechargeable battery, the positive electrode including a mixture of a positive electrode active material containing LiₐM_{b}O_{c} (where M is transition metal; a≠0, b≠0, c≠0) and an inorganic solid electrolyte containing LiₓP_{y}O_{z} (x≠0, y≠0, z≠0).

In the above positive electrode of a lithium-ion rechargeable battery, the positive electrode active material may be crystallized and the inorganic solid electrolyte may be amorphized.

The inorganic solid electrolyte may serve as a base material and particles of the positive electrode active material may be dispersed in the base material.

The positive electrode may contain more LiₐM_{b}O_{c} than LiₓP_{y}O_{z} in terms of molar ratio.

According to a third aspect of the present invention, there is provided a positive electrode of a lithium-ion rechargeable battery, the positive electrode including: a crystalline part being crystallized and containing a positive electrode active material occluding and releasing lithium ions; and an amorphous part being amorphized and containing an inorganic solid electrolyte having lithium ionic conductivity.

According to a fourth aspect of the present invention, there is provided a positive electrode of a lithium-ion rechargeable battery, the positive electrode including: a base material containing an inorganic solid electrolyte having lithium ionic conductivity; and particles dispersed in the base material, the particles containing a positive electrode active material occluding and releasing lithium ions.

### Advantageous Effects of Invention

The present invention can increase a specific capacity of a positive electrode in lithium-ion rechargeable batteries.

### BRIEF DESCRIPTION OF DRAWINGS

FIG. 1 shows a sectional structure of a lithium-ion rechargeable battery of the present embodiment.

FIGS. 2A and 2B show TEM pictures and an electron diffraction picture of the lithium ion rechargeable battery of Example 1.

FIGS. 3A and 3B show specific capacity-voltage characteristics of positive electrode layers of Example 1 and Comparative Example, respectively.

FIGS. 4A and 4B show relationship between a charge/discharge rate and a capacity ratio in Example 1 and Comparative Example.

### DESCRIPTION OF EMBODIMENTS

Embodiments of the present invention will be described in detail below with reference to the attached drawings. In the drawings as referred to in the below description, dimensions of each component, including size and thickness, may differ from actual ones.

### [Structure of the Lithium-Ion Rechargeable Battery]

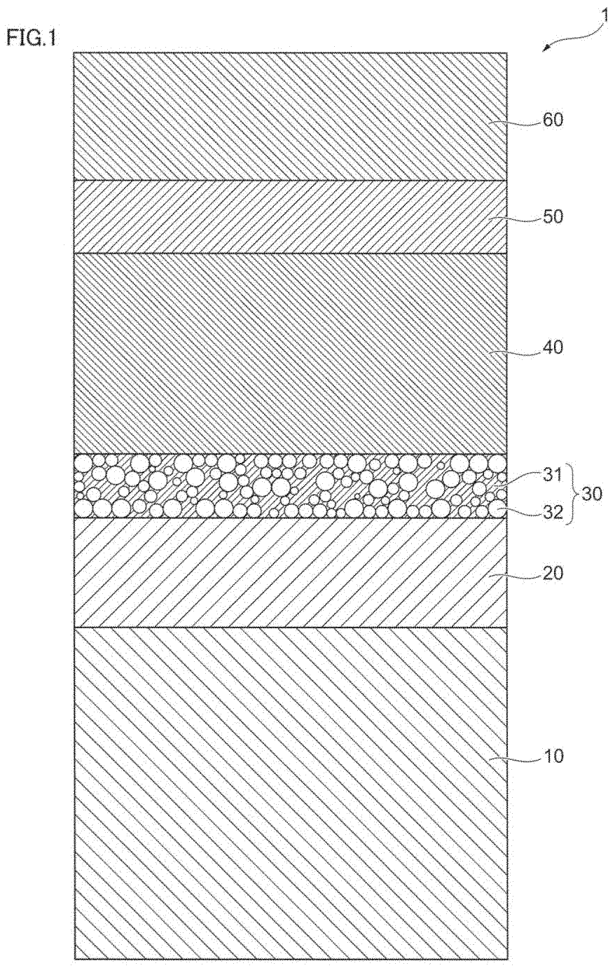

FIG. 1 shows a sectional structure of the lithium-ion rechargeable battery 1.

The lithium-ion rechargeable battery 1 includes: a substrate 10; a positive electrode collector layer 20 stacked on the substrate 10; a positive electrode layer 30 stacked on the positive electrode collector layer 20; an inorganic solid electrolyte layer 40 stacked on the positive electrode layer 30; a negative electrode layer 50 stacked on the inorganic solid electrolyte layer 40; and a negative electrode collector layer 60 stacked on the negative electrode layer 50.

The above constituents of the lithium-ion rechargeable battery 1 of the present embodiment will be described in more detail below.

### (Substrate)

The substrate 10 is not limited to a particular material, and may be made of any of various materials including metal, glass, ceramics, and resin.

In the present embodiment, the substrate 10 is made of resin. Examples of the materials that can be used for the substrate 10 include polycarbonate (PC) fluororesin, polyethylene terephthalate (PET), polybutylene terephthalate (PBT), polyimide (PI), polyamide (PA), polysulfone (PSF), polyether sulfone (PES), polyphenylene sulfide (PPS), polyetheretherketone (PEEK), polyethylene naphthalate (PEN), and cyclo olefin polymer (COP). Desirably, the substrate 10 is made of a material with low hygroscopicity and high moisture resistance.

### (Positive Electrode Collector Layer)

The positive electrode collector layer 20 may be a solid thin film having electron conductivity. As long as these conditions are met, the positive electrode collector layer 20 is not limited to a particular material, and may be made of, for example, a conductive material including metals such as titanium (Ti), aluminum (Al), copper (Cu), platinum (Pt) and gold (Au) and alloy of these metals.

The positive electrode collector layer 20 may have a thickness of 5 nm or more and 50 μm or less. With a thickness of less than 5 nm, the positive electrode collector layer 20 reduces its current collection capability, which makes the lithium-ion rechargeable battery 1 impracticable. With a thickness of more than 50 μm, it takes too much time to form the positive electrode collector layer 20 despite no large change in electrical characteristics, and this reduces productivity.

While any known deposition method may be used to manufacture the positive electrode collector layer 20, such as various PVD (physical vapor deposition) and CVD (chemical vapor deposition) methods, it is preferable to use a sputtering method or a vacuum deposition method in terms of production efficiency.

### (Positive Electrode Layer)

The positive electrode layer 30 is a solid thin film and contains a positive electrode active material that releases lithium ions during a charge and occludes lithium ions during a discharge, and a solid electrolyte made of an inorganic material (inorganic solid electrolyte). This means that the positive electrode layer 30 of the present embodiment is formed of a composite electrode containing the positive electrode active material and the inorganic solid electrolyte. The positive electrode layer 30 of the present embodiment includes a solid electrolyte region 31 mainly containing the inorganic solid electrolyte and a positive electrode region 32 mainly containing the positive electrode active material. In the positive electrode layer 30, the inorganic solid electrolyte constituting the solid electrolyte region 31 and the positive electrode active material constituting the positive electrode region 32 are present while maintaining their form. As a result, one of these substances serves as a matrix (base material) and the other serves as a filler in the positive electrode layer 30. Preferably, the solid electrolyte region 31 serves as the matrix and the positive electrode region 32 serves as the filler in the positive electrode layer 30.

The positive electrode layer 30 may have a thickness of 10 nm or more and 100 μm or less, for example. With the positive electrode layer 30 having a thickness of less than 10 nm, the lithium-ion rechargeable battery 1 obtained therefrom has a too small capacity, which makes the lithium-ion rechargeable battery 1 impracticable. Meanwhile, with the positive electrode layer 30 having a thickness of more than 100 μm, it takes too much time to form the layer, which reduces productivity. The positive electrode layer 30 may, however, have a thickness of more than 100 μm when a large battery capacity is required of the lithium-ion rechargeable battery 1.

While any known deposition method may be used to fabricate the positive electrode layer 30, such as various PVD (physical vapor deposition) and CVD (chemical vapor deposition) methods, it is preferable to use a sputtering method in terms of production efficiency.

### [Solid Electrolyte Region]

The solid electrolyte region 31 mainly contains the inorganic solid electrolyte. Examples of the inorganic solid electrolyte constituting the solid electrolyte region 31 include one made of lithium phosphorus oxide (LiₓP_{y}O_{z}: x≠0, y≠0, z≠0).

While the solid electrolyte region 31 may have either a crystalline structure or an amorphous structure, the solid electrolyte region 31 preferably has an amorphous structure (amorphized) in terms of increased Li-ionic conductivity.

### [Positive Electrode Region]

The positive electrode region 32 mainly contains the positive electrode active material. Examples of the positive electrode active material constituting the positive electrode region 32 include one made of lithium transition metal oxide (LiₐM_{b}O_{c}:a≠0, b≠0, c≠0) containing one or more metals (denoted by M) selected from various transition metals and oxygen.

While the positive electrode region 32 may have either a crystalline structure or an amorphous structure, the positive electrode region 32 preferably has an crystalline structure (crystallized) in terms of making a potential of occluded or released lithium ions constant.

### [Relationship Between the Solid Electrolyte Region and the Positive Electrode Region]

In the positive electrode layer 30 of the present embodiment, the inorganic solid electrolyte in the solid electrolyte region 31 is preferably amorphized, and the positive electrode active material in the positive electrode region 32 is preferably crystallized.

Also, in the positive electrode layer 30 of the present embodiment, the solid electrolyte region 31 containing the inorganic solid electrolyte is preferably the matrix (base material), and the positive electrode region 32 containing the positive electrode active material is preferably the filler (particles) dispersed in the matrix.

When, for example, the solid electrolyte region 31 is made of lithium phosphorus oxide (LiₓP_{y}O_{z}) and the positive electrode region 32 is made of lithium transition metal oxide (LiₐM_{b}O_{c}), the positive electrode layer 30 of the present embodiment preferably contains more lithium transition metal oxide than lithium phosphorus oxide in terms of molar ratio.

### (Inorganic Solid Electrolyte Layer)

The inorganic solid electrolyte layer 40 is a solid thin film and contains a solid electrolyte made of an inorganic material (inorganic solid electrolyte). The inorganic solid electrolyte constituting the inorganic solid electrolyte layer 40 is not limited to a particular material as long as the inorganic solid electrolyte exhibits lithium ionic conductivity, and may be made of any of various materials including oxide, nitride, and sulfide. However, in terms of reducing a potential barrier of lithium ions at the interface between the positive electrode layer 30 and the inorganic solid electrolyte layer 40, it is desirable that the inorganic solid electrolyte constituting the inorganic solid electrolyte layer 40 contain the same element as that of the inorganic solid electrolyte constituting the solid electrolyte region 31 in the above positive electrode layer 30. For example, when the solid electrolyte region 31 of the positive electrode layer 30 is made of LiPO₃, the inorganic solid electrolyte layer 40 may be made of LiPO₃ similarly to the solid electrolyte region 31 or may be made of LiPON, which further contains nitrogen.

The inorganic solid electrolyte layer 40 may have a thickness of 10 nm or more and 10 μm or less, for example. With the inorganic solid electrolyte layer 40 having a thickness of less than 10 nm, the lithium-ion rechargeable battery 1 obtained therefrom is prone to a short circuit (leakage) between the positive electrode layer 30 and the negative electrode layer 50. Meanwhile, with the inorganic solid electrolyte layer 40 having a thickness of more than 10 μm, the migration distance of lithium ions is lengthened, which leads to a slower charge and discharge speed.

The inorganic solid electrolyte layer 40 may have either a crystalline structure or a non-crystalline, amorphous structure. The inorganic solid electrolyte layer 40 is, however, preferably amorphous because the amorphous structure allows for more isotropic thermal expansion and contraction.

While any known deposition method may be used to manufacture the inorganic solid electrolyte layer 40, such as various PVD and CVD methods, it is preferable to use a sputtering method in terms of production efficiency.

### (Negative Electrode Layer)

The negative electrode layer 50 is a solid thin film and contains a negative electrode active material that occludes lithium ions during a charge and releases lithium ions during a discharge. Examples of the negative electrode active material constituting the negative electrode layer 50 include carbon and silicon. The negative electrode layer 50 may be doped with various dopants.

The negative electrode layer 50 may have a thickness of 10 nm or more and 40 μm or less, for example. With the negative electrode layer 50 having a thickness of less than 10 nm, the lithium-ion rechargeable battery 1 obtained therefrom has a too small capacity, which makes the lithium-ion rechargeable battery 1 impracticable. Meanwhile, with the negative electrode layer 50 having a thickness of more than 40 μm, it takes too much time to form the layer, which reduces productivity. The negative electrode layer 50 may, however, have a thickness of more than 40 μm when a large battery capacity is required of the lithium-ion rechargeable battery 1.

The negative electrode layer 50 may have either a crystalline structure or a non-crystalline, amorphous structure. The negative electrode layer 50 is, however, preferably amorphous because the amorphous structure allows for more isotropic expansion and contraction when lithium ions are occluded and released.

While any known deposition method may be used to manufacture the negative electrode layer 50, such as various PVD and CVD methods, it is preferable to use a sputtering method (sputtering) in terms of production efficiency.

### (Negative Electrode Collector Layer)

The negative electrode collector layer 60 may be a solid thin film having electron conductivity. As long as these conditions are met, the negative electrode collector layer 60 is not limited to a particular material, and may be made of, for example, a conductive material including metals such as titanium (Ti), aluminum (Al), copper (Cu), platinum (Pt) and gold (Au) and alloy of these metals.

The negative electrode collector layer 60 may have a thickness of 5 nm or more and 50 μm or less. With a thickness of less than 5 nm, the negative electrode collector layer 60 reduces its current collection capability, which makes the lithium-ion rechargeable battery 1 impracticable. With a thickness of more than 50 μm, it takes too much time to form the negative electrode collector layer 60 despite no large change in electrical characteristics, and this reduces productivity.

While any known deposition method may be used to manufacture the negative electrode collector layer 60, such as various PVD and CVD methods, it is preferable to use a sputtering method (sputtering) or a vacuum deposition method in terms of production efficiency.

### [Operation of the Lithium-Ion Rechargeable Battery]

When the lithium-ion rechargeable battery 1 in a discharged state is charged, a positive electrode of a DC power source is connected to the positive electrode collector layer 20 and a negative electrode of the DC power source is connected to the negative electrode collector layer 60. Then, lithium ions constituting the positive electrode active material in the positive electrode layer 30 move through the inorganic solid electrolyte layer 40 to the negative electrode layer 50, where the lithium ions are accommodated in the negative electrode active material.

When the lithium-ion rechargeable battery 1 in a charged state is used (discharged), a positive side of the load is connected to the positive electrode collector layer 20 and a negative side of the load is connected to the negative electrode collector layer 60. Then, the lithium ions accommodated in the negative electrode active material in the negative electrode layer 50 move through the inorganic solid electrolyte layer 40 to the positive electrode layer 30, where the lithium ions constitute the positive electrode active material. Along with this, a direct current is supplied to the load.

### <Other Notes>

In the present embodiment, the positive electrode collector layer 20 is disposed between the substrate 10 and the positive electrode layer 30. However, the positive electrode collector layer 20 may be removed when the substrate 10 is made of a conductive material such as metal. This is because the substrate 10 made of a conductive material can function as a positive electrode collector.

### EXAMPLES

The present invention will be described in more detail below based on Example. It should be noted that the present invention is not limited to Example given below as long as its scope is not exceeded.

The present inventors fabricated multiple lithium-ion rechargeable batteries 1 while varying the constitution of the respective positive electrode layers 30. The present inventors then evaluated the crystalline structure and composition of the respective positive electrode layers 30 of the thus-obtained lithium-ion rechargeable batteries 1 and also evaluated specific capacities of the thus-obtained lithium-ion rechargeable batteries 1.

Table 1 and Table 2 show the constitution of each layer of the lithium-ion rechargeable battery 1 of Example 1 and Comparative Example, respectively.

TABLE 1

| EXAMPLE 1 | CONSTITUTION | | | |
|---|---|---|---|---|
| MEMBER | MATERIAL | THICKNESS | | STRUCTURE |
| NEGATIVE | Ti | 350 | nm | CRYSTALLINE |
| ELECTRODE | | | | |
| COLLECTOR | | | | |
| LAYER | | | | |
| NEGATIVE | Si(B) | 200 | nm | AMORPHOUS |
| ELECTRODE | | | | |
| LAYER | | | | |
| INORGANIC | LiPON | 550 | nm | AMORPHOUS |
| SOLID | | | | |
| ELECTROLYTE | | | | |
| LAYER | | | | |
| POSITIVE | LiNiO₂ + | 175 | nm | CRYSTALLINE + |
| ELECTRODE | Li₃PO₄ | | | AMORPHOUS |
| LAYER | | | | |
| POSITIVE | Ti | 300 | nm | CRYSTALLINE |
| ELECTRODE | | | | |
| COLLECTOR | | | | |
| LAYER | | | | |
| SUBSTRATE | PC | 1.1 | mm | — |

TABLE 2

| COMPARATIVE | | | | |
|---|---|---|---|---|
| EXAMPLE | CONSTITUTION | | | |
| MEMBER | MATERIAL | THICKNESS | | STRUCTURE |
| NEGATIVE | Ti | 350 | nm | CRYSTALLINE |
| ELECTRODE | | | | |
| COLLECTOR | | | | |
| LAYER | | | | |
| NEGATIVE | Si(B) | 200 | nm | AMORPHOUS |
| ELECTRODE | | | | |
| LAYER | | | | |
| INORGANIC | LiPON | 550 | nm | AMORPHOUS |
| SOLID | | | | |
| ELECTROLYTE | | | | |
| LAYER | | | | |
| POSITIVE | LiNiO₂ | 175 | nm | CRYSTALLINE |
| ELECTRODE | | | | |
| LAYER | | | | |
| POSITIVE | Ti | 300 | nm | CRYSTALLINE |
| ELECTRODE | | | | |
| COLLECTOR | | | | |
| LAYER | | | | |
| SUBSTRATE | PC | 1.1 | mm | — |

Example 1 used the lithium-ion rechargeable battery 1 having the layer structure shown in FIG. 1. Comparative Example used the lithium-ion rechargeable battery 1 having the layer structure shown in FIG. 1 but having a positive electrode layer 30 with a different configuration from that of Example 1. In both of Example 1 and Comparative Example, each layer (the positive electrode collector layer 20, the positive electrode layer 30, the inorganic solid electrolyte layer 40, the negative electrode layer 50, and the negative electrode collector layer 60) was deposited on the substrate 10 using a sputtering method.

### Example 1

The configuration of the lithium-ion rechargeable battery 1 of Example 1 shown in Table 1 is as follows.

In Example 1, polycarbonate (PC) was used as the substrate 10. The thickness of the substrate 10 was 1.1 mm.

In Example 1, titanium (Ti) was used as the positive electrode collector layer 20. The thickness of the positive electrode collector layer 20 was 300 nm.

In Example 1, a mixture (composite electrode) of the solid electrolyte region 31 containing Li₃PO₄ and the positive electrode region 32 containing LiNiO₂ was used as the positive electrode layer 30. The thickness of the positive electrode layer 30 was 175 nm. The ratio (molar ratio) of Li₃PO₄ to LiNiO₂ in a sputtering target for forming the positive electrode layer 30 was Li₃PO₄:LiNiO₂≈1:4.

In Example 1, LiPON obtained by displacing a part of oxygen in Li₃PO₄ with nitrogen was used as the inorganic solid electrolyte layer 40. The thickness of the inorganic solid electrolyte layer 40 was 550 nm.

In Example 1, boron (B)-doped silicon (Si) was used as the negative electrode layer 50. In Table 1, the boron-doped silicon is denoted by “Si (B)” (the same applies below). The thickness of the negative electrode layer 50 was 200 nm.

In Example 1, titanium (Ti) was used as the negative electrode collector layer 60. The thickness of the negative electrode collector layer 60 was 350 nm.

### Comparative Example

The configuration of the lithium-ion rechargeable battery 1 of Comparative Example shown in Table 2 is the same as that of the lithium-ion rechargeable battery 1 of Example 1 except for the positive electrode layer 30. Accordingly, detailed description of the substrate 10, the positive electrode collector layer 20, the inorganic solid electrolyte layer 40, the negative electrode layer 50, and the negative electrode collector layer 60 is omitted.

In Comparative Example, LiNiO₂ was used as the positive electrode layer 30. In other words, in Comparative Example, the positive electrode layer 30 was solely composed of the positive electrode region 32 without the solid electrolyte region 31. The thickness of the positive electrode layer 30 was 175 nm.

### [Evaluation of the Lithium-Ion Rechargeable Batteries]

As measures to evaluate the lithium-ion rechargeable batteries 1 of Example 1 and Comparative Example, the crystalline structure and composition of the positive electrode layer 30 of each lithium-ion rechargeable battery 1 and specific capacity of the positive electrode layer 30 of each lithium-ion rechargeable battery 1 were used.

### (Crystalline Structure)

First, referring to Table 1, the crystalline structure of the lithium-ion rechargeable battery 1 of Example 1 will be described.

In the lithium-ion rechargeable battery 1 of Example 1, the positive electrode collector layer 20 and the negative electrode collector layer 60 were crystallized. The inorganic solid electrolyte layer 40 and the negative electrode layer 50 were amorphized. The positive electrode layer 30 contained a mixture of a crystallized region and an amorphized region.

Then, referring to Table 2, the crystalline structure of the lithium-ion rechargeable battery 1 of Comparative Example will be described.

In the lithium-ion rechargeable battery 1 of Comparative Example, the positive electrode collector layer 20 and the negative electrode collector layer 60 were crystallized. The inorganic solid electrolyte layer 40 and the negative electrode layer 50 were amorphized. The positive electrode layer 30 was entirely crystallized.

The above shows that the positive electrode layers 30 of Example and Comparative Example have a different crystalline structure. Specifically, in Example 1, the positive electrode layer 30 is composed of a mixture of a crystallized region and an amorphized region, whereas in Comparative Example, the positive electrode layer 30 is solely composed of a crystallized region.

Below a more detailed description will be given of the structure of the positive electrode layer 30 of the lithium-ion rechargeable battery 1 of Example 1.

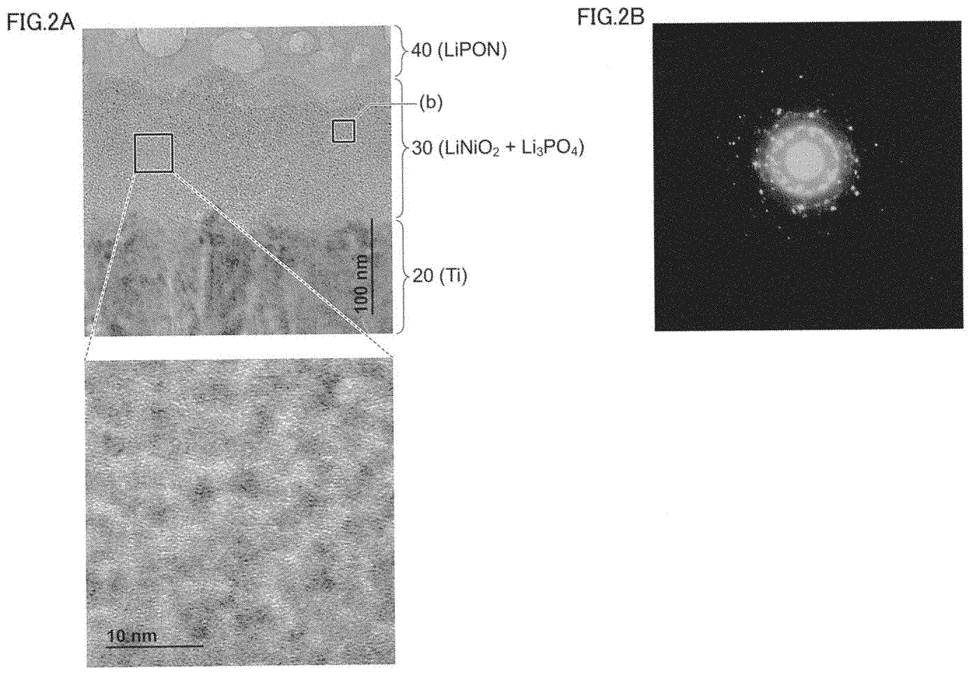

FIGS. 2A and 2B show transmission electron microscope (TEM) pictures and an electron diffraction picture of the lithium-ion rechargeable battery 1 of Example 1. FIG. 2A shows TEM pictures; the upper picture shows the deposited state of the positive electrode collector layer 20, the positive electrode layer 30, and the inorganic solid electrolyte layer 40, and the lower picture shows magnification of a partial area of the positive electrode layer 30. FIG. 2B shows an electron diffraction picture of an area (b) shown in the upper picture of FIG. 2A.

The pictures of FIGS. 2A and 2B were taken by HF-2200 (a field emission analytical electron microscope) from Hitachi High-Technologies Corporation. The TEM has a feature that an image reflecting composition information can be obtained. More specifically, in the TEM, a region containing heavy elements appears relatively black and a region containing light elements appears relatively white.

As shown in the lower picture of FIG. 2A, the positive electrode layer 30 of Example 1 includes both of a region appearing relatively white and a region appearing relatively black. This means that the positive electrode layer 30 of Example 1 is made of a mixture of the region containing relatively light elements, namely the solid electrolyte region 31 not containing transition metal, and the region containing relatively heavy elements, namely the positive electrode region 32 containing transition metal.

As shown in the lower picture of FIG. 2A, in the positive electrode layer 30 of Example 1, the solid electrolyte region 31 appearing relatively white serves as a base material and the positive electrode region 32 appearing relatively black is dispersed in the form of particles in the base material.

A halo pattern and diffraction spots are seen in the picture of FIG. 2B. This means that the positive electrode layer 30 of Example 1 contains a mixture of a crystallized region and an amorphized region.

A TEM picture of the lithium-ion rechargeable battery 1 of Comparative Example showed that the positive electrode layer 30 of Comparative Example only consisted of a region appearing black overall, unlike Example 1. In other words, the positive electrode layer 30 of Comparative Example only consisted of the positive electrode region 32. Also, many diffraction spots were observed from a diffraction electron picture of the positive electrode layer 30 (positive electrode region 32) of the lithium-ion rechargeable battery 1 of Comparative Example. Thus, the positive electrode layer 30 (positive electrode region 32) of Comparative Example was found to have a crystalline structure.

### (Specific Capacity)

The positive electrode layers 30 of the respective lithium-ion rechargeable batteries 1 of Example 1 and Comparative Example were evaluated in terms of specific capacity. The specific capacity of the positive electrode layer 30 refers to a capacity of the positive electrode active material per unit mass.

For evaluation of the specific capacity, charge/discharge characteristics of the lithium-ion rechargeable batteries 1 were measured. As an instrument to measure the charge/discharge characteristics, HJ1020mSD8 charge-discharge device from Hokuto Denko Corporation was used.

The lithium-ion rechargeable batteries 1 of Example 1 and Comparative Example were charged under a constant current-constant voltage (CCCV) mode. End-of-charge voltage was 4.2 V.

Also, the lithium-ion rechargeable batteries 1 of Example 1 and Comparative Example were discharged under a constant current (CC) mode. End-of-discharge voltage was 0.5 V.

The lithium-ion rechargeable battery 1 of Example 1 was charged and discharged under the three conditions of 0.8C, 1.6C, and 3.1C. Meanwhile, the lithium-ion rechargeable battery 1 of Comparative Example was charged and discharged under the three conditions of 0.9C, 1.8C and 3.6C. Here, “C” refers to an electric current value with which discharge of cells having a given nominal capacity value is completed in one hour when the cells are discharged at constant current. For example, 1C=3.5 A for the cells having a nominal capacity value of 3.5 Ah. Hereinafter, this may be referred to as a charge/discharge rate.

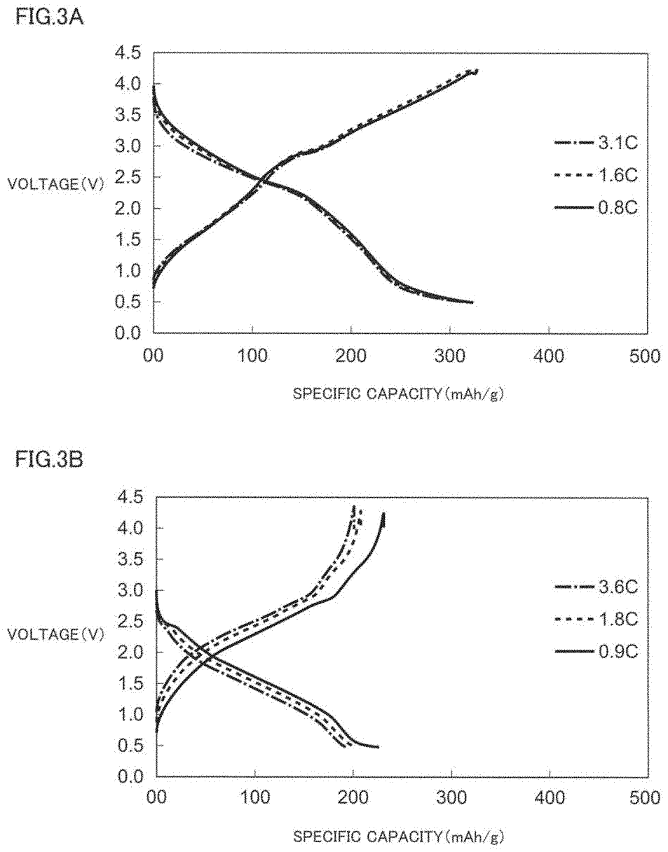

FIGS. 3A and 3B depict specific capacity-voltage characteristics of the positive electrode layers 30 of Example 1 and Comparative Example, respectively. FIG. 3A shows the results of Example 1, and FIG. 3B shows the results of Comparative Example. In each of FIGS. 3A and 3B, the horizontal axis represents the specific capacity (mAh/g) of the positive electrode layer 30, and the vertical axis represents the voltage (V), which means an electrode potential of the positive electrode layer 30.

As can be seen in FIGS. 3A and 3B, the positive electrode layer 30 of Example 1 has a larger specific capacity than the positive electrode layer 30 of Comparative Example. This means that, in terms of the specific capacity, it is more preferable to use the positive electrode layer 30 containing a mixture of the positive electrode active material (lithium transition metal oxide (LiₐM_{b}O_{c}:a≠0, b≠0, c≠0)) and the inorganic solid electrolyte (lithium phosphorus oxide (LiₓP_{y}O_{z}: x≠0, y≠0, z≠0)) than to use the positive electrode layer 30 not containing a mixture of the positive electrode active material and the inorganic solid electrolyte.

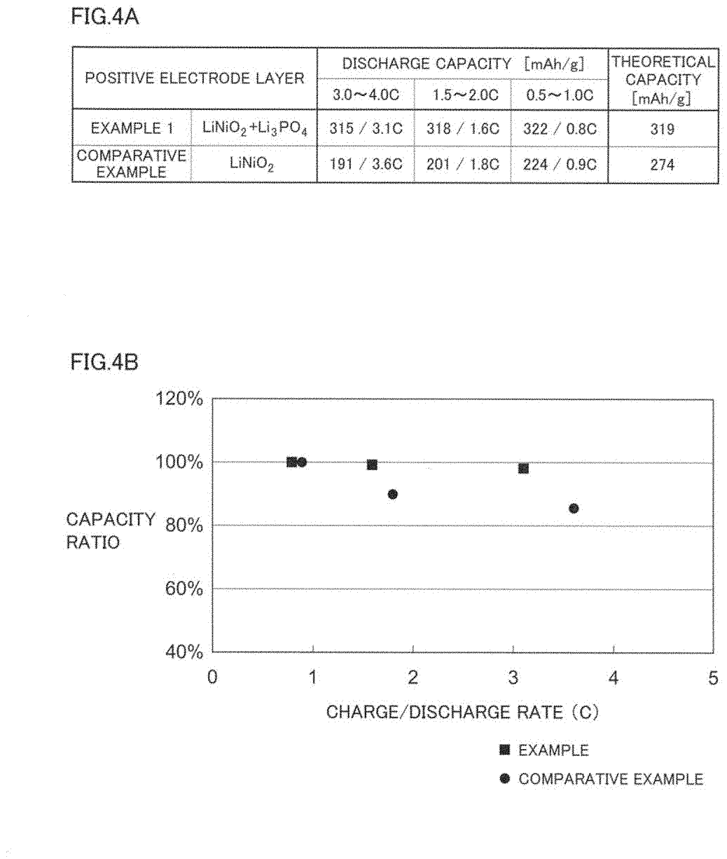

FIGS. 4A and 4B depict relationship between a charge/discharge rate and a capacity ratio in Example 1 and Comparative Example. FIG. 4A depicts an actual discharge capacity and a theoretical capacity of the positive electrode layers 30 of Example 1 and Comparative Example. FIG. 4B depicts charge/discharge rate-capacity ratio characteristics of the positive electrode layers 30 of Example 1 and Comparative Example. The capacity ratio on the vertical axis of FIG. 4B represents a value obtained by dividing each discharge capacity of each positive electrode layer 30 by the discharge capacity at each minimum charge/discharge rate (0.8C in Example 1 and 0.9C in Comparative Example), namely represents the ratio of discharge capacity.

First, referring to FIG. 4A, theoretical capacities of the positive electrode layers 30 of Example 1 and Comparative Example will be compared.

In Example 1, the theoretical capacity of the positive electrode layer 30 was 319 (mAh/g). In Comparative Example, the theoretical capacity of the positive electrode layer 30 was 274 (mAh/g). This means that the theoretical capacity of the positive electrode layer 30 of Comparative Example is smaller than that of the positive electrode layer 30 of Example 1.

Then, referring to FIG. 4A, actual discharge capacities of the positive electrode layers 30 of Example 1 and Comparative Example will be compared.

In Example 1, the discharge capacity was 315 (mAh/g) at the charge/discharge rate of 3.1C, 318 (mAh/g) at the charge/discharge rate of 1.6C, and 322 (mAh/g) at the charge/discharge rate of 0.8C. In Comparative Example, the discharge capacity was 191 (mAh/g) at the charge/discharge rate of 3.6C, 201 (mAh/g) at the charge/discharge rate of 1.8C, and 224 (mAh/g) at the charge/discharge rate of 0.9C.

Then, referring to FIG. 4B, the relationship between the charge/discharge rate and the capacity ratio of each of the positive electrode layers 30 of Example 1 and Comparative Example will be described.

In Example 1, the capacity ratio is stable at nearly 100% regardless of whether the charge/discharge rate is high or low. On the other hand, in Comparative Example, the capacity ratio decreases with increase in the charge/discharge rate.

### REFERENCE SIGNS LIST

1 Lithium-ion rechargeable battery
10 Substrate
20 Positive electrode collector layer
30 Positive electrode layer
31 Solid electrolyte region
32 Positive electrode region
40 Inorganic solid electrolyte layer
50 Negative electrode layer
60 Negative electrode collector layer

1. A lithium-ion rechargeable battery comprising:
a solid electrolyte layer containing a solid electrolyte having lithium ionic conductivity; and
a positive electrode layer facing the solid electrolyte layer, the positive electrode layer including a mixture of a positive electrode active material containing LiₐM_{b}O_{c} (where M is transition metal; a≠0, b≠0, c≠0) and an inorganic solid electrolyte containing LiₓP_{y}O_{z} (x≠0, y≠0, z≠0).

2. The lithium-ion rechargeable battery according to claim 1, wherein, in the positive electrode layer, the positive electrode active material is crystallized and the inorganic solid electrolyte is amorphized.

3. The lithium-ion rechargeable battery according to claim 1, wherein, in the positive electrode layer, the inorganic solid electrolyte serves as a base material and particles of the positive electrode active material are dispersed in the base material.

4. The lithium-ion rechargeable battery according to claim 1, wherein the positive electrode layer contains more LiₐM_{b}O_{c} than LiₓP_{y}O_{z} in terms of molar ratio.

5. The lithium-ion rechargeable battery according to claim 1, wherein the solid electrolyte constituting the solid electrolyte layer contains the same element as the inorganic solid electrolyte constituting the positive electrode layer.

6. A positive electrode of a lithium-ion rechargeable battery, the positive electrode comprising a mixture of a positive electrode active material containing LiₐM_{b}O_{c} (where M is transition metal; a≠0, b≠0, c≠0) and an inorganic solid electrolyte containing LiₓP_{y}O_{z} (x≠0, y≠0, z≠0).

7. The positive electrode of a lithium-ion rechargeable battery according to claim 6, wherein the positive electrode active material is crystallized and the inorganic solid electrolyte is amorphized.

8. The positive electrode of a lithium-ion rechargeable battery according to claim 6, wherein the inorganic solid electrolyte serves as a base material and particles of the positive electrode active material are dispersed in the base material.

9. The positive electrode of a lithium-ion rechargeable battery according to claim 6, wherein the positive electrode contains more LiₐM_{b}O_{c} than LiₓP_{y}O_{z} in terms of molar ratio.

10. A positive electrode of a lithium-ion rechargeable battery, the positive electrode comprising:
a crystalline part being crystallized and containing a positive electrode active material occluding and releasing lithium ions; and
an amorphous part being amorphized and containing an inorganic solid electrolyte having lithium ionic conductivity.

11. A positive electrode of a lithium-ion rechargeable battery, the positive electrode comprising:
a base material containing an inorganic solid electrolyte having lithium ionic conductivity; and
particles dispersed in the base material, the particles containing a positive electrode active material occluding and releasing lithium ions.
